(19) United States
(12) Patent Application Publication
(10) Pub. No.: US 2026/0081522 A1
(43) Pub. Date: Mar. 19, 2026

(54) CURRENT DETECTION CIRCUIT

(71) Applicant: Infineon Technologies AG, Neubiberg (DE)

(72) Inventors: Giulio MANFREDA, Villach (AT); Sureshkumar RAMALINGAM, Villach (AT)

(21) Appl. No.: 18/886,226

(22) Filed: Sep. 16, 2024

(51) Int. Cl. H02M 3/158; H02M 1/00

(52) U.S. Cl. CPC H02M 3/158; H02M 1/0009

(57) ABSTRACT

Circuits, devices, and methods for detecting a load current of a power stage are described. According to some aspects, a power stage includes a pass device and a current sense device. A detection circuit is configured to detect a load current through the pass device based on comparing a first voltage associated with the pass device with a second voltage associated with the current sense device biased by a reference current. In some examples, the detection circuit is intermittently operable as a wakeup circuit to detect a change in one or more loads, for example that the one or more loads have turned on and started to draw current.

### TECHNICAL FIELD OF THE INVENTION

This invention relates generally to power circuitry, and more specifically techniques for detecting a current through one or more loads supplied by the power circuitry.

### BACKGROUND

In some applications, power circuitry may be used to supply energy to components of an electrical system. In some examples, an electrical system and/or components of an electrical system may be operated in a low power consumption state when not in use to reduce energy consumption. For example, when an automotive vehicle is parked, one or more component(s) of the vehicle electrical system may be turned off (i.e., disconnected from power) or operated in a sleep mode (still supplied with power but not fully operational) so the component(s) consume power.

In some examples, a vehicle electrical system may include circuitry configured to periodically wake and perform a routine to measure a current supplied to vehicle electrical system components to determine whether one or more of the components, or load(s), have changed state. A need exists for improved current detection circuits that may be implemented with reduced cost and/or complexity in comparison with traditional circuits. A further need exists for current detection circuits that operate with improved power consumption, accuracy, and/or flexibility in comparison to traditional circuits.

### SUMMARY

This disclosure is directed to improvements in current detection, for example to detect a change in one or more loads of a power stage. According to some aspects, a detection circuit includes a comparator. The comparator is configured to compare a first voltage associated with a pass device configured to supply energy to a load with a second voltage associated with a current sense device coupled to the pass device and biased with a reference current. The comparator detects a change in the load based on comparing the first voltage to the second voltage.

According to some aspects, a method is described. The method includes comparing a first voltage associated with a pass device configured to supply energy to one or more loads with a second voltage associated with a current sense device coupled to the pass device and biased with a reference current. The method further includes detecting a change in the one or more loads based on comparing the first voltage to the second voltage.

According to some aspects, a power device is described that includes at least one package and a power stage housed within the at least one package and including a gate controller that controls a pass device configured to supply energy to one or more loads. The power device further includes a current sense device coupled to the pass device, and a detection circuit coupled to the power stage and housed within the at least one package. The detection circuit is configured to compare a first voltage associated with the pass device with a second voltage associated with the current sense device and biased with a reference current. The detection circuit is also configured to detect a change in the one or more loads based on comparing the first voltage to the second voltage.

### BRIEF DESCRIPTION OF THE DRAWINGS

FIG. 1 is a block diagram that depicts one example of a power circuitry that includes a power stage and a detection circuit according to some embodiments.

FIG. 2 is a block diagram that depicts one example of a power device that includes a power stage and a detection circuit according to some embodiments.

FIG. 3 is a flow diagram that depicts respective modes of operation of a detection circuit according to some embodiments.

FIG. 4 is a timing diagram showing plots that show respective first and second voltages, a load current, and a load detect signal vs time according to some embodiments.

FIG. 5 is a timing diagram that depicts operation of a detection circuit to detect a change in one or more load(s) according to some embodiments.

FIG. 6 is a flow diagram that depicts one example of a method of detecting a current according to some embodiments.

### DETAILED DESCRIPTION

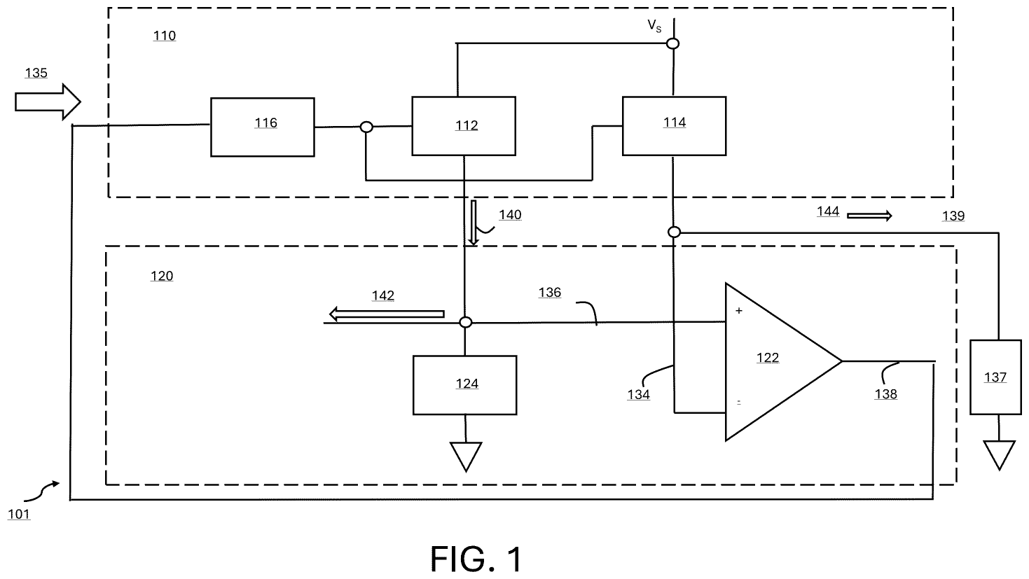

FIG. 1 is a block diagram that depicts power circuitry 101 that includes a power stage 110 and a detection circuit 120 configured to detect a change in one or more load(s) 137 that are supplied energy by a power stage 110 according to some embodiments. The power stage 110 includes a pass device 114, which may be a power metal oxide semiconductor (MOSFET) transistor configured to be switched on and off by a gate controller 116 to regulate energy from a supply voltage Vs to one or more load(s) 137. One example of such a power MOSFET is a double diffusion MOSFET, which may be referred to as a DMOS. The gate controller 116 may operate to switch on and off the pass device 114 according to a to supply a desired amount of energy to the load(s) 137. For example, the gate controller 116 may control the pass device 114 at least in part based on measured feedback, for example from a current sense device 112, which is coupled to the pass device 114 and configured to generate a sense current ISENSE that is proportional to the load current I_{L}. The sense current ISENSE may have a magnitude proportional to a magnitude of the load current I_{L}, and is used to monitor the load current I_{L}.

Power stage 110 may be used alone or in conjunction with components to implement one or more electrical systems, for example to supply energy to components used in an automotive vehicle. For example, power stage 110 may be part of a power distribution circuit (not shown in FIG. 1) configured to transfer energy from a power source, such as a battery, electrical grid, or other power source, to one or more load(s) 137 (hereinafter referred to as load(s) 137, meaning either a singular load or plural loads), which may be a component of a vehicle system, non-limiting examples of which include a motor, a sensor, communications or networking components, lighting, and/or a chargeable power source such as a battery. In some examples, at least some components of a vehicle electrical systems are operated in a low-power consumption mode when the vehicle and/or the specific components are not in use to reduce power consumption.

In some examples, a traditional power stage may employ circuitry to measure a load current I_{L}. For example, some traditional power stages may include V_{DS} sensing circuitry coupled to monitor a voltage across a drain and source terminal of a pass device as an approximation of the load current I_{L}. In some examples, such traditional V_{DS} sensing circuitry may calculate the load current I_{L} as a function of R_{DS}(ON) of the pass device, which represents a resistance of the pass device when operated in a linear region. In some examples, such traditional V_{DS} sensing circuitry is unsuitable for measurement of a load current I_{L}, when the pass device is operated in a saturation region. In addition, such traditional V_{DS} sensing may not be sufficiently accurate (e.g., less than 30%) for some applications. In addition, it may also be complex to implement adjustable thresholds for traditional V_{DS} sensing circuitry.

Other traditional power stages may include a current sense device that enables detection of a load current I_{L} more precisely than V_{DS} sensing circuitry. According to these examples, a traditional current sense device may be coupled to a pass device and configured to output a sense current that is proportional to a load current I_{L} through the pass device. According to such a traditional power stage, generate a replica of the load current as the sense current and convert it to a voltage across a resistor that is compared to a reference voltage to monitor the load current I_{L}. In some examples, a traditional current sense device may operate with higher accuracy than traditional V_{DS} sensing as described above, and may also be operable to measure the load current I_{L} when the pass device is operated in a linear region as well as when the pass device is operated in a saturation region. In some examples, a stable reference voltage used for comparison in a traditional current sense device may require expensive and/or complex to implement components, such as a band gap reference. In some examples, a stable reference voltage used for comparison in a traditional current sense device may also be costly or difficult make adjustable. In some examples, a traditional current sense device may consume a significant amount of power to measure a load current I_{L}.

The power stage 110 depicted in FIG. 1 includes a detection circuit 120 uniquely configured to detect a change one or more load(s) 137 coupled to an output V_{OUT} 139 of the power stage 110. In some examples, instead of comparing a voltage that represents a difference between a sense current I_{SENSE} and a load current I_{L} to a voltage reference as for a traditional current sense circuits, the detection circuit 120 of FIG. 1 detects a change in the load(s) 137 based on comparing a first voltage 134 associated with the pass device 114 to a second voltage 136 associated with the current sense device 112 that is biased by a reference current I_{REF} 142.

For example, the detection circuit 120 shown in FIG. 1 includes a comparator 122 that compares the first voltage 134 and the second voltage 136 biased by the reference current I_{REF} to generate a difference output 138, which may be sent as a load detect signal 135 that indicates a change in the load current I_{L} was detected if the first voltage 134 falls below a threshold defined by the second voltage 136. In some examples, the second voltage 136 is adjustable to increase or decrease the threshold to trigger the load detect signal 135, for example by decreasing or increasing the reference current I_{REF} used to bias the second voltage 136.

In some examples, detection circuit 120 may offer advantages in comparison to traditional techniques for measuring a load current I_{L}. For example, by comparing the first voltage 134 to the second voltage 136 biased by the reference current I_{REF} to detect a change in the load(s) 137, the detection circuit 120 may be implemented with reduced cost and/or complexity in comparison to traditional techniques that use a reference voltage for comparison. In addition, a threshold for the detection circuit 120 to detect a change in the load(s) 137 may be easily adjusted, by changing the reference current I_{REF} without the cost or complexity associated with traditional techniques. In some examples, such a threshold may be set lower than in comparison to traditional techniques, which may enable more accurate and/or early detection of a change in the load(s) 137.

In some examples, the detection circuit 120 is operable as a wake up circuit that operates while the power stage 110 and/or components of the power stage 110 are operated in a sleep state to reduce power consumption. In some examples, the detection circuit 120 is operable to detect a current I_{L} through the pass device 114 if the pass device 114 is operated in a linear region or a saturation region, allowing greater flexibility for the gate controller 116 to enable the pass device 114 for current measurement during wakeup.

When used as a wakeup circuit, the detection circuit 120 may operate in an idle state defined by a sleep timer, and intermittently awaken from the idle state to measure the load current IL, for example to detect a change in the load(s) 137, i.e., that the load(s) 137 have changed state. For example, the detection circuit 120 may detect that the load(s) 137 have started to draw current. As non-limiting examples, the load(s) 137 may change state because one or more of the load(s) 137 have awaken from a sleep mode to start operating (i.e., due to operator input, sensor input, and/or expiration of a timer), have been turned on (i.e., coupled to a power source), and/or have experienced a fault (i.e., a short circuit of other fault), that causes the load(s) 137 to start drawing current (i.e., draw more current than the load(s) had previously drawn). In some examples, the detection circuit 120 generates a load detect signal 135 if a change in the load(s) 137 is detected. In some examples, the load detect signal 135 is sent to a gate controller 116 to operate the pass device 114 (e.g., drive the pass device 114 on and off with a defined duty cycle) to supply energy to the load(s) 137 responsive to the load detect signal 135. In other examples, the load detect signal 135 may also, or instead, be sent to diagnostic circuitry (not shown in FIG. 1), that performs one or more diagnostic routines involving one or more components of the power stage 110, detection circuit 120, or other associated components responsive to the load detect signal 135. In still other examples, the load detect signal 135 may also, or instead, be supplied to protection circuitry (not shown in FIG. 1) that decouples one or more components of power stage 110 from a power source or otherwise protects power stage 110 from damage. In still other examples, the load detect signal 135 may be sent as an interrupt to one or multiple systems/components.

In some examples, the detection circuit 120 may alternate between operating in 1) a drift correction stage in which the comparator 122 is deactivated (and consumes little or no power) and the reference current I_{REF} 142 is activated to bias and sample the second voltage 136 across the charge storage device 124, and 2) a wake detect stage in which the reference current I_{REF} is deactivated (and consumes little or no power), and the comparator 122 is activated to compare the first voltage 134 and the second voltage 136 and generate the difference output 138.

According to these examples, the detection circuit 120 may advantageously be configured to operate with reduced power consumption in comparison to traditional techniques while operating with high accuracy to detect a change in the load(s) 137, for example to detect whether the load(s) 137 have turned on and start drawing current.

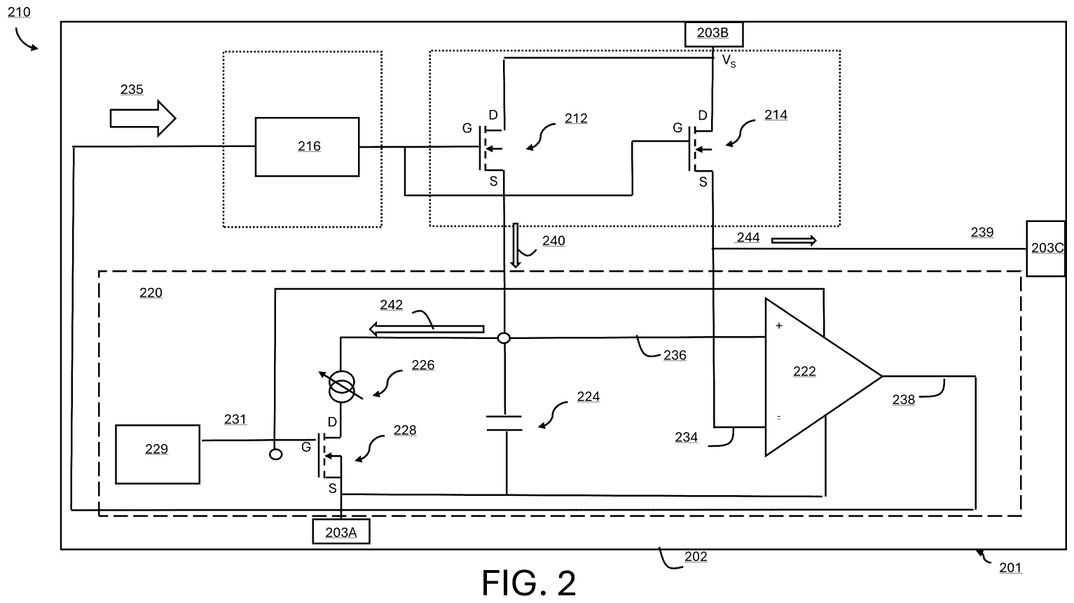

FIG. 2 is a block diagram depicting one example of a power device 201 that includes a power stage 210 and a detection circuit 220 according to some embodiments. In the example of FIG. 2, power stage 210 includes a pass transistor 214, a current sense transistor 212, and a gate controller 216. In the example of FIG. 2, the pass transistor 214, the current sense transistor 212, the gate controller 216 and the detection circuit 220 are housed in the same package 202 and coupled to external circuitry through I/O ports 203A-203C on the package 202. In other examples not depicted, one or more of the pass transistor 214, the current sense transistor 212, the gate controller 216 and the detection circuit 220 may be housed in separate packages. As shown by the dotted boxes in FIG. 2, in some examples, the pass transistor 214 and the current sense transistor 212 may be monolithically integrated in the same silicon substrate, and the gate controller 216 may implemented in a separate silicon substrate housed in the same or a different package. In some examples, the detection circuit 220 may be integrated with the gate controller 216 and/or the pass transistor 214, or implemented in a separate substrate in the same or a different package.

As shown in the example of FIG. 1, the pass transistor 214 includes gate, drain, and source terminals. In some examples, the pass transistor 214 is a power semiconductor device particularly configured to be driven to control the supply of energy from a source to one or more load(s) 137. For example, the pass transistor 214 may be silicon based power metal oxide semiconductor (MOSFET) one example of which is a DMOS, a gallium nitride power device, a silicon carbide based power device, or any device configured to be switched on and off to transfer energy between an energy source and one or more load(s) 137.

As shown in FIG. 2, a drain terminal of the pass transistor 214 is coupled to a supply voltage Vs through an I/O port 203B on the package 202, and a source terminal of the pass transistor 214 is coupled to an output V_{OUT} 239 of the power stage 210, which may be coupled to the load(s) 137 through I/O port 203C on the package 202. As shown in the FIG. 1 example, the load(s) 137 may be coupled between the output voltage V_{OUT} and a ground reference GND.

As shown in FIG. 2, a gate terminal of the pass transistor 214 is coupled to be driven by a gate controller 216 of the power stage 110, which includes circuitry configured to generate a control signal with sufficient current to drive the pass transistor 214 on and off to transfer a desired amount of energy to the load(s) 137 via the I/O port 203C.

As shown in FIG. 2, the power stage 210 further includes a current sense transistor 212, which may include a portion of the pass transistor 214 (e.g., part of the same silicon structure) used for current sensing, or a separate component from the pass transistor 214 coupled to the pass transistor 214 as shown. As shown in FIG. 1, the current sense transistor 212 includes a drain terminal coupled to supply voltage V_{S} and the drain terminal of the pass transistor 214, and a gate terminal coupled to an output of the gate controller 216 and the gate terminal of the pass transistor 214. A source terminal of the current sense transistor 212 couples the sense current I_{SENSE} 240 through the current sense transistor 212 to the detection circuit 220 to be measured. The current I_{SENSE} may represent the load current I_{L} 244. For example, the sense current I_{L} may have a magnitude proportional to a magnitude of the load current I_{L} 244. In some examples, key parameter of the current sense transistor 212 may be referred to as a K_{ILIS} ratio between the load current I_{L} 244 and the sense current I_{SENSE} 240 according to the following equation:

$${K}_{ILIS =} {I}_{L} / {I}_{S E N S E} \qquad ( 1 )$$

As shown in FIG. 2, the detection circuit 220 includes a timer circuit 229, a switch 228, a current source 226, a capacitor 224, and a comparator 222. The comparator 222 is configured to compare a first voltage 234 (the output voltage V_{OUT}) at a negative input of the comparator 222 with a second voltage 236 at a positive terminal of the comparator 222 and generate a difference output 238, clocked by a clock signal CLK 231 from the timer circuit 229. In some examples, the comparator 222 is configured to be alternately activated to perform a comparison, or deactivated to reduce power consumption responsive to transitions in the clock signal CLK 231. For example, the comparator 222 may operate such that in response to a first transition of the clock signal CLK 231 (e.g., from a low to a high voltage), the comparator 222 operates to compare the first voltage 234 to the second voltage 236, and in response to a second transition of the clock signal CLK 231 (e.g., from high to low, i.e., the opposite of the first transition), the comparator 222 is deactivated and consumes little or no power, and the output 238 of the comparator 222 is blanked (e.g., coupled to a ground reference GND).

As shown in FIG. 2, a capacitor 224 is coupled between the second voltage 236 and a ground reference GND, for example via the I/O port 203A on the package 202. The current source 226 is coupled to the second voltage 236 to bias the second voltage 236 with a reference current I_{REF} 242. The switch 228 is coupled between the current source 226 and the ground reference GND. The switch 228 includes a gate terminal coupled to be driven by the clock signal CLK 231 from the timer circuit 229 to activate or deactivate the reference current I_{REF} 242. In some examples, the switch 228 is configured to be operated based on the same clock signal CLK 231 from the timer circuit 229 that controls the comparator 222. In some examples, the switch 228 is configured to activate or deactivate the reference current I_{REF} 242 responsive to transitions in the clock signal CLK 231, which may be opposite transitions of the clock signal CLK 231 to those that trigger activation of the comparator 222 as described above. For example, in response to a first transition of the clock signal CLK 231 (e.g., from high to low) the switch 228 may be turned off to decouple the current source 226 and deactivate the reference current I_{REF} 242, and in response to a second transition of the clock signal CLK 231 (e.g., from low to high), the switch 228 may be turned on to couple the current source 226 and activate the reference current I_{REF} 242.

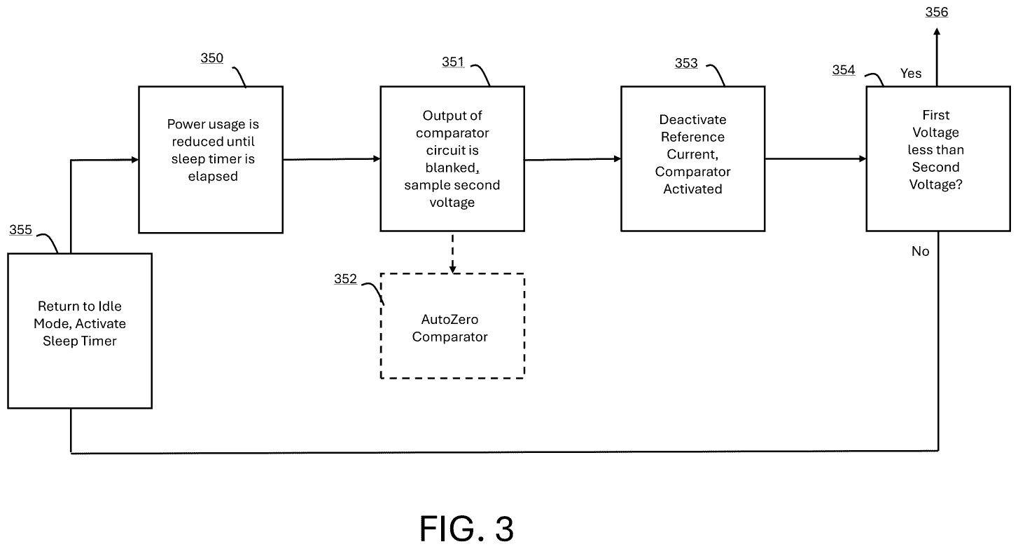

FIG. 3 is a flow diagram that depicts respective modes of operation of the detection circuit 220 depicted in FIG. 2 to detect a change in one or more load(s) 137 according to some embodiments. In the example of FIG. 3, the detection circuit 220 is configured to operate in an idle stage 350 in which power consumption by the power stage 210 and detection circuit is minimized. For example, in the idle stage 350, the gate controller 216 may not operate to supply a gate drive signal to the pass transistor 214, and the pass transistor 214 and/or current sense transistor 212 may be turned off, and/or may be disconnected from a power supply V_{S}. As other examples, in the idle stage 350, components of the detection circuit 220 may be turned off and/or disconnected from power. For example, the switch 228 may be turned off, disconnecting the current source 226 from power. As another example, the comparator 222 may be deactivated in the idle stage 350.

As shown in FIG. 3, the detection circuit 220 may remain in the idle stage 350 until a sleep timer has elapsed. Once the sleep timer has elapsed, the detection circuit 220 operates to detect a change in the load(s) 137 coupled to an output of the power stage 210, for example whether the load(s) 137 have turned on and started drawing current. In addition, in some examples, once the sleep timer has elapsed, the gate controller 216 controls the pass transistor 214 to turn on such that a change in the load(s) 137 can be detected. For example, in response to the sleep timer elapsing, the gate controller 216 may apply a gate drive signal that operates the pass transistor 214 in a liner region or in a saturation region of the pass transistor 214.

As shown in FIG. 3, after the sleep timer has elapsed, the detection circuit 220 may operate in a drift correction stage 351 followed by a wake check stage 353. In the drift correction stage 351, responsive to the clock signal CLK 231 from the timer circuit 229, an output of the comparator 222 is blanked, and the switch 228 is turned on, coupling the current source 226 to the second voltage 236 so that the reference current I_{REF} 242 biases the second voltage 236. In the drift correction stage 351, the second voltage 236, biased by the reference current I_{REF} 242, is sampled (i.e., stored) across the capacitor 224. As shown in FIG. 3, in an optional embodiment, at 352, the comparator 222 is autozeroed in the drift correction stage 351, which may improve accuracy of the comparator 222.

After the drift correction stage 351, the detection circuit 220 is operated in a wake check stage 353. In the wake check stage 353, the reference current I_{REF} 242 is deactivated, for example by turning off the switch 228 and decoupling the current source 226 from the ground reference GND. In the wake check stage 353, the current source 226 may consume little or no energy. In the wake check stage 353, the comparator 222 is activated to compare the first voltage 234 and the second voltage 236. As shown at 354 in the FIG. 3 example, if the first voltage 234 does not fall below the second voltage 236 in the wake check stage 353, the detection circuit 220 may not output a load detect signal 235, and at 355 returns to the idle stage 350 and activates the sleep timer. However, if the first voltage 234 falls below the second voltage 236, at 356 the detection circuit 220 outputs the load detect signal 235, which indicates that one or more load(s) 137 have changed state, for example by starting to draw a load current I_{L} 244. In some examples, the load detect signal 235 is output to the gate controller 216, and the gate controller 216 drives the pass transistor 214 turn on and off to transfer energy to the load(s) 137. In other examples, the load detect signal 235 is sent to diagnostics circuitry that perform one or more diagnostics routines responsive to the load detect signal 235. In other examples, the load detect signal 235 is sent to protection circuitry that engages protection measures in response to the load detect signal 235, such as to decouple the pass transistor 214 and/or other components from a power source. In still other examples, the load detect signal 235 may be sent as an interrupt to one or multiple components or systems.

After the wake check stage 353, if the detection circuit 220 does not determine that the load(s) 137 have changed state (the first voltage 234 does not fall below the second voltage 236), then the detection circuit 220 may return to the idle stage 350 of operation as described above, including starting the sleep timer. The detection circuit 220 may remain in the idle stage 350 until the sleep timer has elapsed, and again operate in the drift correction stage 351 and wake check stage 353 as described to detect a change in the load(s) 137 each time the sleep timer elapses.

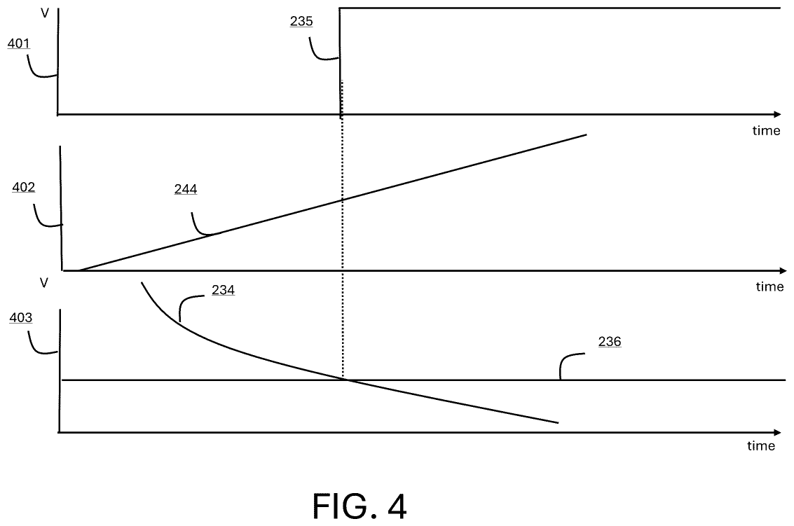

FIG. 4 is a timing diagram showing plots 401-403 that show the respective first and second voltages 234, 236, a load current I_{L}, and a load detect signal 235 vs time according to some embodiments. As shown in plot 402, the load current I_{L} is steadily increasing with time, for example due to one or more load(s) 137 being activated. As shown in plot 402, the second voltage 236, which is biased by a reference current I_{REF}, remains substantially constant and serves as a threshold to trigger a load detect signal 235 as shown in plot 401. As shown in plot 401, as the load current I_{L} increases in plot 402, the first voltage 234 decreases. As shown in plot 403, when the first voltage 234 falls below the second voltage 236 in plot 401, the detection circuit 220 causes the load detect signal 235 to change state to indicate a change in the load(s) 137, for example that the load(s) 137 have turned on and started drawing current.

As shown by the plots 401-403 in FIG. 4, the second voltage 236 serves as a threshold to trigger detection of a change in the load(s) 137. In some examples, the second voltage 236 is adjustable to increase or decrease the sensitivity and/or accuracy of the detection circuit 220. For example, the second voltage 236 may be increased by operating the current source 226 to decrease a magnitude of the reference current I_{REF} 142 used to bias the second voltage 236. As another example the second voltage 236 may be decreased by operating the current source 226 to increase the magnitude of the reference current I_{REF} 242 used to bias the second voltage 236.

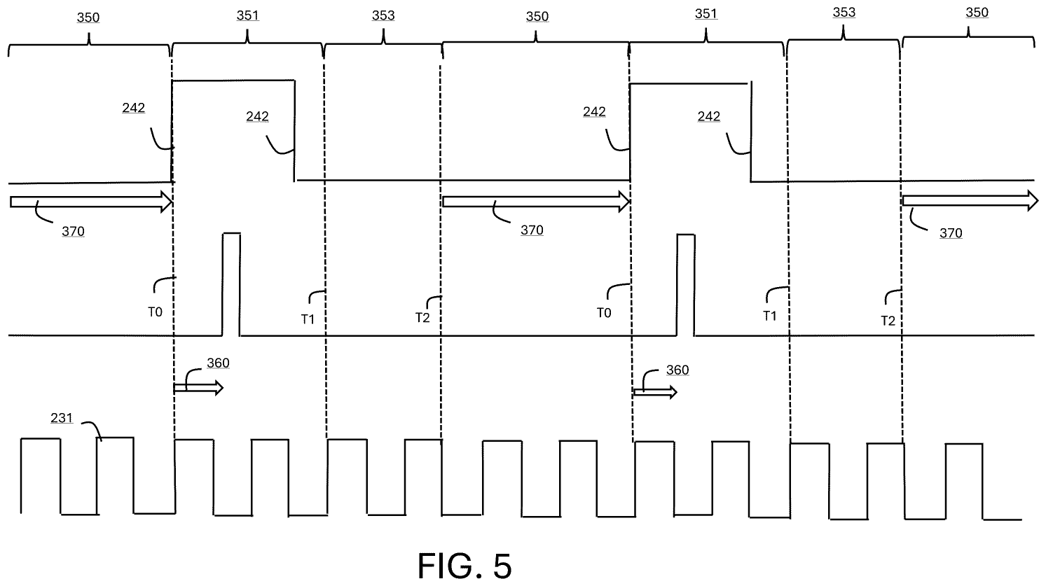

FIG. 5 is a timing diagram that depicts operation of the detection circuit 220 according to some embodiments. As shown in the example of FIG. 5, the detection circuit 220 operates based on a clock signal CLK 231, which may be generated by a timer circuit 229 or received from elsewhere, such as via an I/O port on package 202.

As shown in FIG. 5, the detection circuit 220 may be operated in an idle stage 350. In the idle stage 350, the detection circuit 220 is operated to consume as little power as possible. For example, the comparator 222 and or current source 226 may be deactivated in the idle stage 350. In some examples, the detection circuit 220 operates in the idle stage 350 until a sleep timer 370 has elapsed. The sleep timer 370 may be defined, for example, based on a number of cycles of the clock signal CLK 231. In the example of FIG. 5., the sleep timer 370 has a duration of 2.5 clock cycles, or four transitions of the clock signal CLK 231. In other examples, the sleep timer 370 may be defined with a longer duration. For example, the sleep timer 370 may be defined with a duration substantially larger than the drift correction stage 351 and/or the wake check stage 353 depicted in FIG. 5. In some examples, the sleep timer 370 may be tens of times longer than the drift correction stage 351 and/or the wake check stage 353, or hundreds or thousands of times longer than the drift correction stage 351 and/or the wake check stage 353, depending on the application.

As shown in FIG. 5, once the sleep timer 370 has elapsed, the detection circuit 220 is operated in the drift correction stage 351. Upon the sleep timer elapsing, the reference current I_{REF} 242 is enabled, for example by operating the switch 228 to enable the current source 226 to generate the reference current I_{REF} 242 to bias the second voltage 236. In the drift correction stage 351, an output of the comparator 222 is zeroed, and the comparator is deactivated. As shown in FIG. 5, after applying a delay 360 once the reference current I_{REF} 242 enabled, the second voltage 236 is sampled across the capacitor 224 responsive to a transition (e.g., from high to low in the FIG. 5 example) in the clock signal CLK 231, i.e., a charge associated with the second voltage 236 biased by the reference current I_{REF} 242 is stored by the capacitor 224. As shown in FIG. 5, after the second voltage 236 is sampled across the capacitor 224, the detection circuit 220 disables the reference current I_{REF} 242, for example operating by the switch 228 to disconnect the current source 226 to deactivate the reference current I_{REF} 242.

As shown in FIG. 5, after disabling the reference current, the detection circuit 220 is operated in the wake check stage 353. In the wake check stage 353, with the reference current I_{REF} 242 disabled, the comparator 222 is operated responsive to a transition (low to high in the FIG. 5 example) in the clock signal CLK 231 to compare the first voltage 234 and the second voltage 236. In some examples, the detection circuit 220 is operated in the wake check stage 353 to compare the first voltage 234 and the second voltage 236 across multiple cycles of the clock signal CLK 231. For example, FIG. 5 shows the detection circuit 220 operated in the wake check stage 353 over two cycles of the clock signal CLK 231, during which the comparator 222 may perform two comparisons responsive to two transitions (e.g., low to high) in the clock signal CLK 231. In other examples, the detection circuit 220 may be operated in the wake check stage 353 over more clock cycles than shown in FIG. 5 such that the comparator 222 performs more comparisons, or a single clock cycle such that the comparator 222 performs only a single comparison of the first voltage 234 and the second voltage 236 in the wake check stage 353.

At the end of the wake check stage 353, whether based on a single or multiple comparisons, the detection circuit 220 outputs a load detect signal 235 if the detection circuit 220 determines that the first voltage 234 has fallen below the second voltage 236, which indicates a change in the one or more load(s) 137, i.e., that the load(s) 137 have begun drawing a load current I_{L}. In contrast, if the detection circuit 220 determines that the first voltage 234 has not fallen below the second voltage 236 in the wake check stage 353, as shown in the FIG. 5 example, the detection circuit 220 returns to the idle stage 350, and activate the sleep timer 370. As shown in FIG. 5, once the sleep timer 370 has elapsed, the detection circuit 220 returns to the drift correction stage 351 and the wake check stage 353, respectively.

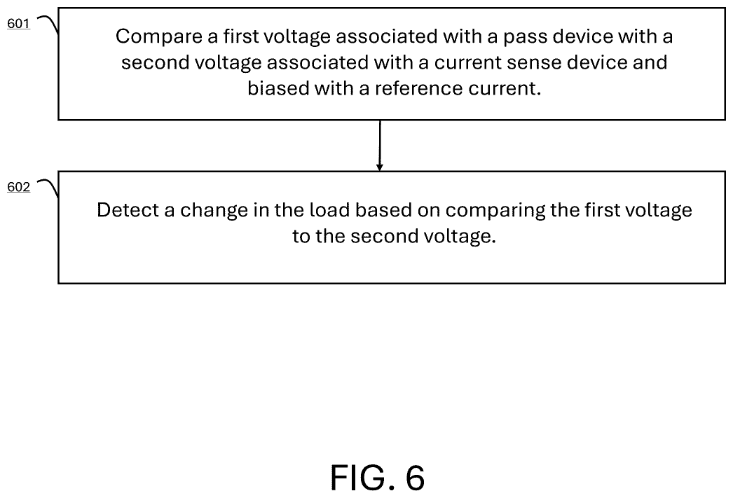

FIG. 6 is a flow diagram that depicts one example of a method of operating a current detection circuit according to some embodiments. As shown in FIG. 6, at 601, the method includes comparing a first voltage 134 associated with a pass device 114 configured to supply energy to one or more load(s) 137 with a second voltage 136 associated with a current sense device 112 coupled to the pass device 114 and biased with a reference current I_{REF} 142. As also shown in FIG. 6, at 602 the method further includes detecting a change in the load(s) 137 based on comparing the first voltage 134 to the second voltage 136.

In some examples, the method further includes using a current source 226 coupled to the second voltage 236 to bias the second voltage 236 with the reference current I_{REF} 242. In some examples the method further includes adjusting the second voltage 236 by controlling a magnitude of the reference current I_{REF} 242. In some examples the method further includes clocking the comparator 222 by a timer circuit 229.

In some examples, the method further includes using a switch 228 to activate or deactivate the current source 226. In some examples, the method further includes clocking the switch 228 by the timer circuit 229. In some examples, the method further includes sampling the second voltage 236 using a charge storage device 124 (e.g., a capacitor 224).

In some examples, the method further includes operating the detection circuit 120 in a wake check stage 353 after a sleep timer has elapsed in an idle stage 350. In some examples, the method further includes, in the wake check stage 353, activating the comparator 122 to compare the first voltage 134 and the second voltage 136. In some examples, the comparator 122 consumes current in the wake check stage 353 and other components of the detection circuit do not consume current in the wake check stage 353. In some examples, the method further includes deactivating the reference current I_{REF} 142 in the wake check stage 353. In some examples, the method further includes operating the detection circuit 120 in a drift correction stage 351 before operating in the wake check stage 353, wherein the drift correction stage 351 includes blanking an output of the comparator 122 and sampling the second voltage 136. In some examples, the method further includes autozeroing the comparator 122 in the drift correction stage 351.

In some examples, the method further includes triggering the pass device 114 to supply energy to the load(s) 137 if the first voltage 134 is less than the second voltage 136. In some examples, the method further includes triggering a protection mechanism if the first voltage 134 is less than the second voltage 136. In some examples, the method further includes triggering an interrupt signal if the first voltage 134 is less than the second voltage 136. In some examples, the method further includes entering an idle stage and not triggering the pass device to supply energy to the load if the first voltage 134 is greater than the second voltage 136.

### Clauses

Clause 1. A detection circuit, comprising: a comparator configured to compare a first voltage associated with a pass device configured to supply energy to one or more loads with a second voltage associated with a current sense device coupled to the pass device and biased with a reference current; and detect a change in the one or more loads based on comparing the first voltage to the second voltage.

Clause 2. The detection circuit of clause 1, wherein the second voltage is adjustable by controlling a magnitude of the reference current.

Clause 3. The detection circuit any of clauses 1 and 2, wherein the comparator is clocked by a timer device.

Clause 4. The detection circuit of clause 3, further comprising: a switch configured to activate or deactivate a current source circuit that generates the reference current.

Clause 5. The detection circuit of clause 4, wherein the switch is clocked by the timer device.

Clause 6. The detection circuit of any of clauses 1 to 5, wherein the detection circuit is operable in a wake check stage after a sleep timer has elapsed in an idle stage.

Clause 7. The detection circuit of clause 6, wherein in the wake check stage, the detection circuit activates the comparator to compare the first voltage and the second voltage, and deactivates the reference current.

Clause 8. The detection circuit of any of clauses 6 and 7, wherein the comparator consumes current in the wake check stage and other components of the detection circuit do not consume current in the wake check stage.

Clause 9. The detection circuit of any of clauses 6 to 8, wherein the detection circuit is operable in a drift correction stage before operating in the wake check stage, wherein in the drift correction stage, the detection circuit: blanks an output of the comparator; and samples the second voltage.

Clause 10. The detection circuit of clause 9, wherein in the drift correction stage, the detection circuit autozeros the comparator.

Clause 11. The detection circuit of any of clauses 1-10, wherein, responsive to the first voltage falling below the second voltage, the detection circuit triggers one or more of: the pass device to supply energy to the one or more loads; a protection circuit to engage a protection mechanism; and outputting an interrupt signal.

Clause 12. The detection circuit of any of clauses 1-10, wherein the detection circuit enters an idle stage and does not trigger the pass device to supply energy to the one or more loads if the first voltage is greater than the second voltage.

Clause 13. A method, comprising: comparing a first voltage associated with a pass device configured to supply energy to one or more loads with a second voltage associated with a current sense device coupled to the pass device and biased with a reference current; and detecting a change in the one or more loads based on comparing the first voltage to the second voltage.

Clause 14. The method of clause 13, further comprising: adjusting the second voltage by controlling a magnitude of the reference current.

Clause 15. The method of any of clauses 13 and 14, further comprising: clocking a comparator with a timer device.

Clause 16. The method of clause 15, further comprising: using a switch to activate or deactivate a current source circuit that generates the reference current.

Clause 17. The method of clause 16, further comprising: clocking the switch with the timer device.

Clause 18. The method of any of clauses 13-17, further comprising: operating in a wake check stage after a sleep timer has elapsed in an idle stage.

Clause 19. The method of clause 18, further comprising: in the wake check stage, activating a comparator to compare the first voltage and the second voltage, and deactivating the reference current.

Clause 20. The method of any of clauses 18 and 19, wherein the comparator consumes current in the wake check stage and other components do not consume current in the wake check stage.

Clause 21. The method of any of clauses 18 to 20, further comprising: operating in a drift correction stage before operating in the wake check stage, comprising: blanking an output of the comparator; and sampling the second voltage.

Clause 22. The method of any of clause 21, further comprising: autozeroing the comparator in the drift correction stage.

Clause 23. The any of clauses 13-22, wherein responsive to the first voltage falling below the second voltage the method further comprises one or more of: triggering the pass device to supply energy to the one or more loads; triggering a protection mechanism; and triggering an interrupt signal.

Clause 24. The method of any of clauses 13 to 23, further comprising: entering an idle stage and not triggering the pass device to supply energy to the one or more loads if the first voltage does not fall below the second voltage.

Clause 25. A power circuit comprising: at least one package; a power stage housed within the at least one package and comprising a gate controller that controls a pass device configured to supply energy to one or more loads, and a current sense device coupled to the pass device, and a detection circuit coupled to the power stage and housed within the package and configured to: compare a first voltage associated with the pass device with a second voltage associated with the current sense device and biased with a reference current; and detect a change in the one or more loads based on comparing the first voltage to the second voltage.

Clause 26. The power circuit of clause 25, further comprising: wherein the second voltage is adjustable by controlling a magnitude of the reference current.

Clause 27. The power circuit of any of clauses 25 and 26, further comprising a comparator that is clocked by a timer device.

Clause 28. The power circuit of any of clauses 25 to 27, wherein the detection circuit is operable in a wake check stage in which the detection circuit activates the comparator to compare the first voltage and the second voltage, and a drift correction stage in which the detection circuit blanks an output of the comparator and samples the second voltage.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A detection circuit, comprising:
a comparator configured to:
compare a first voltage associated with a pass device configured to supply energy to one or more loads with a second voltage associated with a current sense device coupled to the pass device and biased with a reference current; and
detect a change in the one or more loads based on comparing the first voltage to the second voltage.

2. The detection circuit of claim 1, wherein the second voltage is adjustable by controlling a magnitude of the reference current.

3. The detection circuit of claim 1, wherein the comparator is clocked by a timer device.

4. The detection circuit of claim 3, further comprising:
a switch configured to activate or deactivate a current source circuit that generates the reference current.

5. The detection circuit of claim 4, wherein the switch is clocked by the timer device.

6. The detection circuit of claim 1, wherein the detection circuit is operable in a wake check stage after a sleep timer has elapsed in an idle stage.

7. The detection circuit of claim 6, wherein in the wake check stage, the detection circuit activates the comparator to compare the first voltage and the second voltage, and deactivates the reference current.

8. The detection circuit of claim 6, wherein the comparator consumes current in the wake check stage and other components of the detection circuit do not consume current in the wake check stage.

9. The detection circuit of claim 6, wherein the detection circuit is operable in a drift correction stage before operating in the wake check stage, wherein in the drift correction stage, the detection circuit:
blanks an output of the comparator; and
samples the second voltage.

10. The detection circuit of claim 9, wherein in the drift correction stage, the detection circuit autozeros the comparator.

11. The detection circuit of claim 1, wherein, responsive to the first voltage falling below the second voltage, the detection circuit triggers one or more of:
the pass device to supply energy to the one or more loads;
a protection circuit to engage a protection mechanism; and
outputting an interrupt signal.

12. The detection circuit of claim 1, wherein the detection circuit enters an idle stage and does not trigger the pass device to supply energy to the one or more loads if the first voltage is greater than the second voltage.

13. A method, comprising:
comparing a first voltage associated with a pass device configured to supply energy to one or more loads with a second voltage associated with a current sense device coupled to the pass device and biased with a reference current; and
detecting a change in the one or more loads based on comparing the first voltage to the second voltage.

14. The method of claim 13, further comprising:
adjusting the second voltage by controlling a magnitude of the reference current.

15. The method of claim 13, further comprising:
clocking a comparator with a timer device.

16. The method of claim 15, further comprising:
using a switch to activate or deactivate a current source circuit that generates the reference current.

17. The method of claim 16, further comprising:
clocking the switch with the timer device.

18. A power circuit comprising:
at least one package;
a power stage housed within the at least one package and comprising a gate controller that controls a pass device configured to supply energy to one or more loads, and a current sense device coupled to the pass device, and
a detection circuit coupled to the power stage and housed within the package and configured to:
compare a first voltage associated with the pass device with a second voltage associated with the current sense device and biased with a reference current; and
detect a change in the one or more loads based on comparing the first voltage to the second voltage.

19. The power circuit of claim 18, further comprising:
wherein the second voltage is adjustable by controlling a magnitude of the reference current.

20. The power circuit of claim 18, wherein the detection circuit is operable in a wake check stage in which the detection circuit activates the comparator to compare the first voltage and the second voltage, and a drift correction stage in which the detection circuit blanks an output of the comparator and samples the second voltage.
